(19) United States
(12) Patent Application Publication
(10) Pub. No.: US 2012/0280163 A1
(43) Pub. Date: Nov. 8, 2012

(54) Septic leach line control apparatus

(75) Inventor: Dennis Lunder, Mission Hills, CA (US)

(73) Assignee: VALTERRA PRODUCTS, INC.

(21) Appl. No.: 13/068,094

(22) Filed: May 3, 2011

(51) Int. Cl. E03F 7/02; F16L 5/00; F16K 3/00

(52) U.S. Cl. 251/326; 137/364; 137/368

(57) ABSTRACT

A septic leach line control apparatus comprising a hollow housing with tapered continuous sidewalls extending from a top to a wider base at the bottom. The hollow housing includes a flange extending outwardly from the base and a wider inner flange extending inwardly from the base within the housing. The inner flange defines a vertical elongated opening conformed to engage a pipe or similarly configured conduit, which has a top end and a bottom end. Also provided is a gate valve assembly, including a gate valve, a gate valve housing, and a gate valve handle assembly with a handle attached to an elongated rod at one end and to the gate valve at the other end. The rod with the attached handle extends through the pipe into the hollow housing. The bottom end of the pipe at least partially, if not entirely, encloses the gate valve assembly, or at the very least, the uppermost section of the gate valve housing. The top end of the pipe seals off the juncture where the pipe connects to the vertical elongated tubular opening.

### BACKGROUND OF THE INVENTION

1. Field of the Invention

This invention relates generally to an apparatus used in combination with a septic leach line control system and, more particularly, to a new and improved device for housing and enabling the operation of the controls for a gate valve assembly buried deep in the ground.

2. Description of the Prior Art

Septic leach drain lines are normally buried deep beneath the ground surface to keep from freezing and/or to coordinate effectively with a septic tank and the other components of a septic system or the like. Gate valves are integrally connected to these lines to control waste flowing to the septic tank. Gate valve assemblies designed for this purpose are similarly buried deep in the ground.

The problem that arises with these kinds of systems and the gate valve assemblies in particular regards the difficulty in accessing and ensuring the integrity of the controls for the buried gate valves to enable the opening and closing of the valve, as required. Manual gate valves typically employ an elongated rod with a handle at one end attached to the gate valve at the other. Lifting the rod by the handle operates to open the valve allowing for the flow of waste from one section of the leach line to the other. Pressing or pushing the rod downwards or in the opposite direction operates to close the valve and stop the flow of waste through the valve opening. Valves located several feet below the ground surface, which is common, are often difficult to operate without some means to access the controls at or near the ground surface. Thus, the gate valve may be operated remotely through the use of an elongated handle apparatus that extends from the valve assembly to or just beneath the ground surface. Still, to ensure ease of access and operability, and to ensure the integrity of the controls, and their protection from pests and the like, there is a need to enclose the handle apparatus in a secure and segregated environment. To accomplish this, a protective housing must be provided to enclose the handle at a location at or near the ground surface. Also required is a means to enclose and protect the integrity of the elongated rod portion of the handle assembly and the environment extending between the housing and the gate valve assembly, specifically to prevent obstacles in the ground from interfering with or obstructing the movement of the controls and ground elements, such as pests, water, and the like, from weakening or deteriorating the control's components or any other elements that may be associated with the apparatus.

The prior art relevant to the subject matter of the present invention includes: application Ser. No. 11/954,198 (Pub. No. US2009/0145917A1) with a publication date of Jun. 11, 2009 filed by Wojcik Dec. 11, 2009, for an irrigation box for housing water valves and pipes in the shape of a truncated four-sided pyramid with the sides tapering outwardly from the top to the base. The base includes an outwardly extending flange. Also shown is a lockable lid section;

U.S. Pat. No. 3,482,030 issued Dec. 2, 1969 to Wisniewski for a flush mounted receptacle with a trapezoid-shaped cross-section for use in the ground to contain electrical and television cable connections. The receptacle includes a housing and a removable top plate for access to the interior, which includes a bell-shaped inner housing to prevent water from rising. A locking bar is also provided to prevent against unauthorized access to the inner housing;
U.S. Pat. No. 3,858,755 issued Jan. 7, 1975 to Tellen for a meter box designed to be buried in the ground with a flush mounted cover or top portion. The cover is hinged to the top of the meter box and includes a locking mechanism affixed to the underside of the cover. The locking mechanism includes a cammed latch for engaging a flange on the box and a flexible spring which is confined against a rigid strengthening rib formed on the underside of the cover. The locking mechanism is engageable by a tool inserted through the top cover wall which, when manipulated, bends the spring against the rigid rib to release the latch;
U.S. Pat. No. 4,872,575 issued Oct. 10, 1989 to Kobilan for a protective container for housing underground devices, such as valves, meters and the like. The container includes four walls and a top. Normally the bottom is open. This container is designed to interlock with one or more similar containers with a variety of configurations that are custom-configured for the desired configurations of interconnecting assemblies of valves, pipes, etc. buried in the ground;
U.S. Pat. No. 6,899,240B2 issued May 31, 2005 to Dang et al. for a vault intended for use below ground to house utility connections. The housing includes a reinforced skirt at one end and a seat in the other. A lid is provided to fit upon the seat to close one end. A clip is provided for fastening the lid to the housing; and,
U.S. Pat. No. 7,635,431 B1 issued Dec. 22, 2009 to Tyler for a subterranean control box used in combination with a septic drain line flow control system. Each drain in the system is provided with a control box having a float controlled inlet valve, which normally is in the open position. When the flow rate becomes excessive, or the water table rises, the float shifts the valve to a closed position, thus redirecting the flow to another line.

Nothing in the prior art, including in particular the aforesaid cited references, regards a device or system with the combination of structural elements and relationship of components, and the specific means and objectives as the improved septic leach line control apparatus of the present invention.

The improved septic leach line control apparatus of the present invention comprises a hollow housing having tapered continuous side walls extending from the top of the housing to its base, which includes a bottom plate with an outwardly extending flange and a larger inwardly extending flange which defines an opening conformed to engage an elongated vertical pipe. Used in combination with the apparatus of the present invention is a gate valve assembly, which includes a gate valve housing, a gate valve, and a gate valve handle assembly operatively connected to the gate valve. The gate valve handle assembly consists of an elongated rod attached to the gate valve at one end and to a handle at the other. The pipe, or tube configured similarly, which engages the hollow housing at the upper end where the opening is formed in the base plate, also engages all or a portion of the gate valve assembly at the lower end in conforming relation to protect against the intrusion of pests and pernicious ground elements.

### SUMMARY OF THE INVENTION

The septic leach line control apparatus of the present invention comprises a hollow housing having tapered continuous sidewalls extending from a top section to a wider base at the bottom. The hollow housing includes a base plate with a flange extending outwardly from the base and a wider inner flange extending inwardly from the base within the housing. The inner flange defines a vertical slightly elongated opening conformed to engage a pipe or similarly configured conduit, which has a top end and a bottom end. Also provided is a gate valve assembly, including a gate valve, a gate valve housing, and a gate valve handle assembly with a handle attached to an elongated rod at one end and to the gate valve at the other end. The rod with the attached handle extends through the pipe into the hollow housing. The bottom end of the pipe encloses, at least partially, if not entirely, the gate valve housing or, at the very least, the uppermost section of the gate valve housing.

Accordingly, the object of the present invention is to provide a new and improved septic leach line control apparatus that includes a control box structurally designed to resist sinking below the ground surface.

Another object of the present invention is to provide a new and improved septic leach line control apparatus that includes a control box structurally designed to resist being lifted from below due to a rising water table or freeze thrust.

Another object of the present invention is to provide a new and improved septic leach line control apparatus that includes a control box structurally designed to preclude access to gophers and other underground pests.

Another object of the present invention is to provide a new and improved septic leach line control apparatus that includes a secure environment between and including the control box and the gate valve assembly to ensure the integrity of the gate valve handle assembly.

Another object of the present invention is to provide a new and improved septic leach line control apparatus that includes a control box for use in providing easy access to the gate valve handle assembly required to operate the gate valve buried deep in the ground.

Still another object of the present invention is to provide a new and improved septic leach line control apparatus that includes an enclosed environment between the control box and the gate valve assembly to ensure an effective, continuous and unimpeded operation of the gate valve.

Still another object of the present invention is to provide a new and improved septic leach line control apparatus that is easy to install, operate and maintain.

Still another object of the present invention is to provide a new and improved septic leach line control apparatus that is easy and cost effective to manufacture.

Other objects and advantages of the present invention will become apparent in the following specifications when considered in light of the attached drawings wherein a preferred embodiment of the invention is illustrated.

### BRIEF DESCRIPTION OF THE DRAWINGS

FIG. 1 is a cross-sectional perspective view of the septic leach line control apparatus in accordance with the present invention.

FIG. 2 is an alternative cross-sectional perspective view of the septic leach line control apparatus in accordance with the present invention.

FIG. 3 is a cross-sectional perspective view of the control box element of the septic leach line control apparatus in accordance with the present invention shown just prior to being placed in the ground and encasing the uppermost section of the gate valve handle assembly.

FIG. 4 is a cross-sectional perspective view of the control box element of the septic leach line control apparatus in accordance with the present invention shown after its placement in the ground and encasement of the uppermost section of the gate valve handle assembly.

FIG. 5 is a perspective view of the control box element of the septic leach line control apparatus in accordance with the present invention shown along line 5 of FIG. 1.

FIG. 6 is a top perspective view of the control box element of the septic leach line control apparatus in accordance with the present invention.

FIG. 7 is a bottom perspective view of the control box element of the septic leach line control apparatus in accordance with the present invention.

FIG. 8 is an exploded view of the control box element of the septic leach line control apparatus in accordance with the present invention.

### DETAILED DESCRIPTION OF THE PREFERRED EMBODIMENT

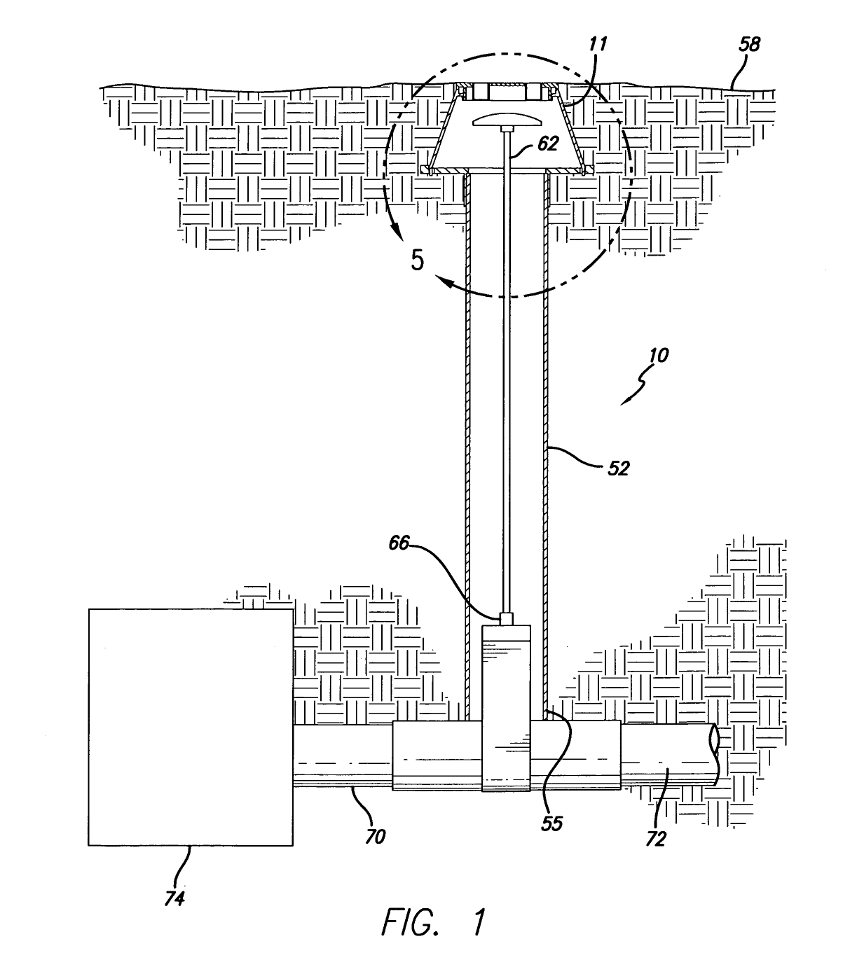

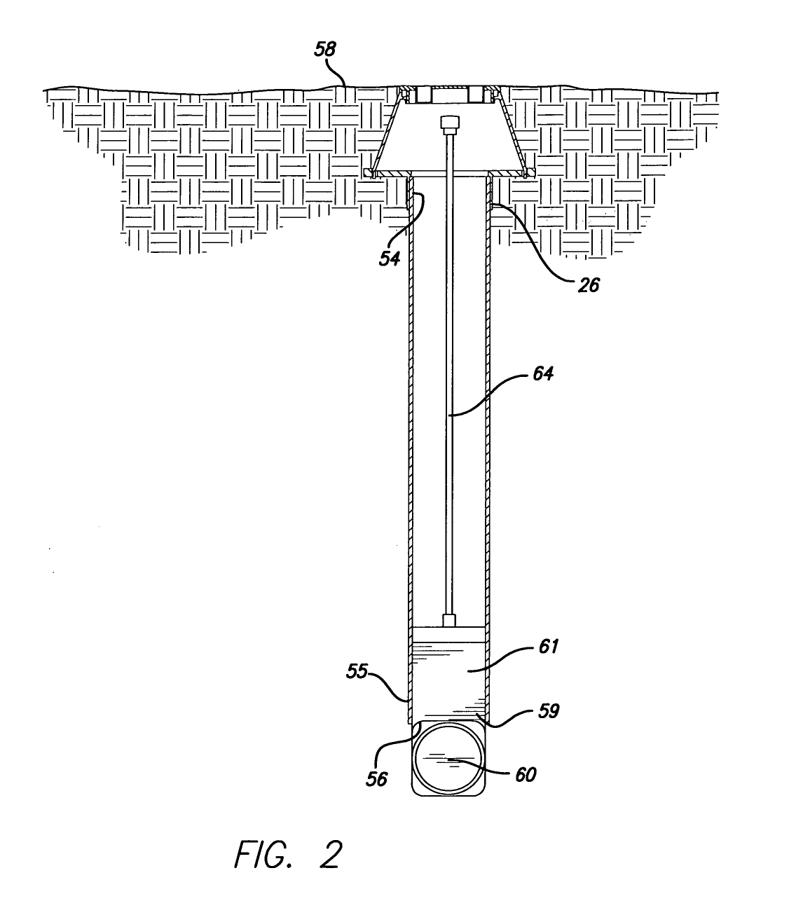

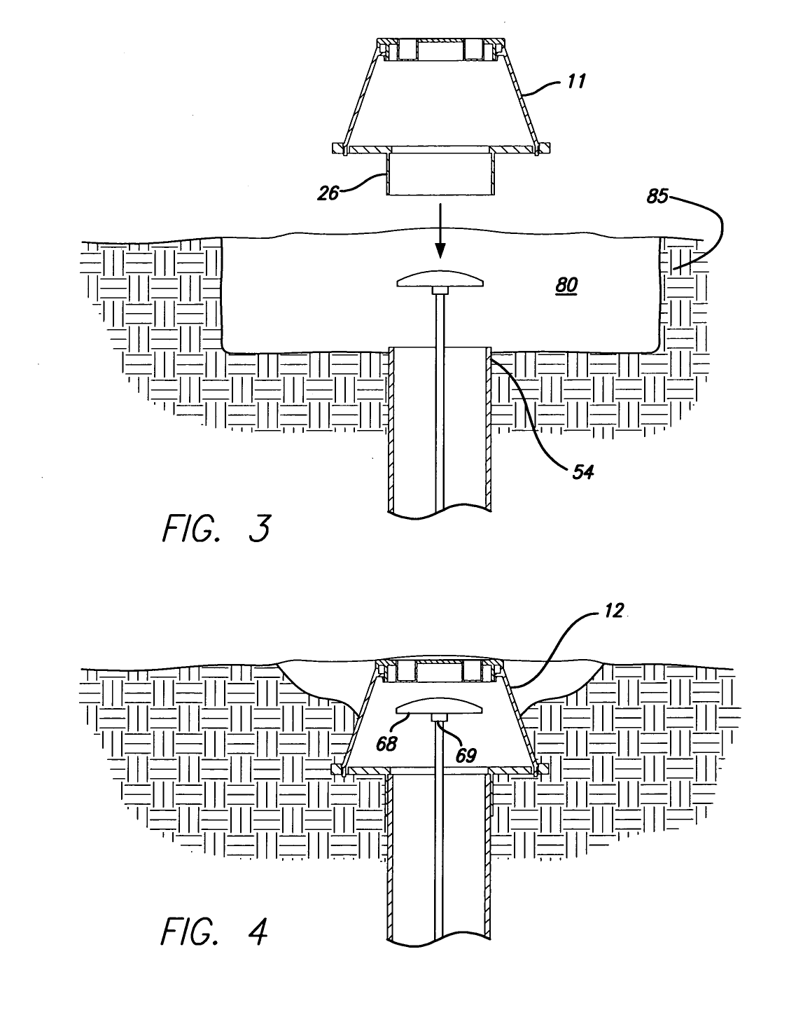

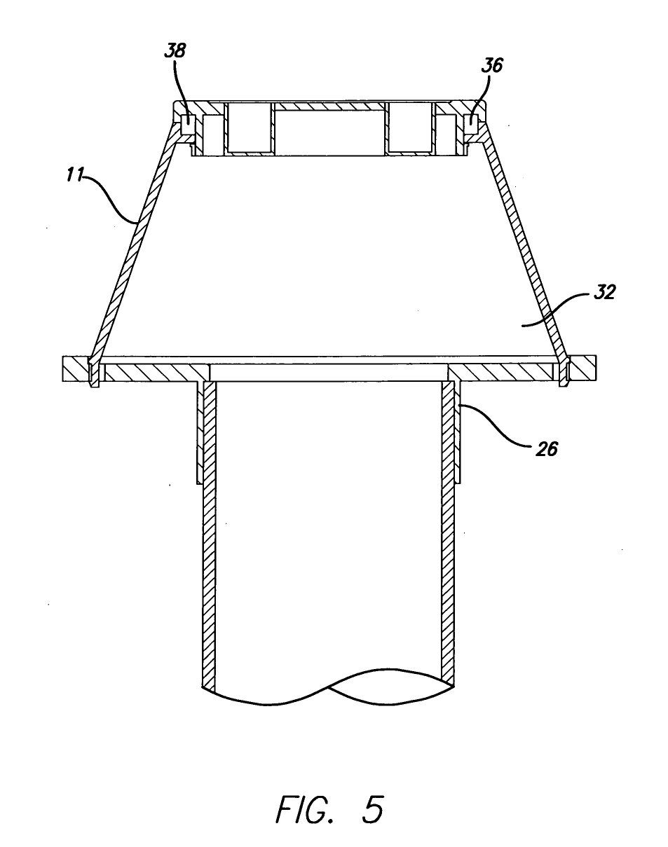

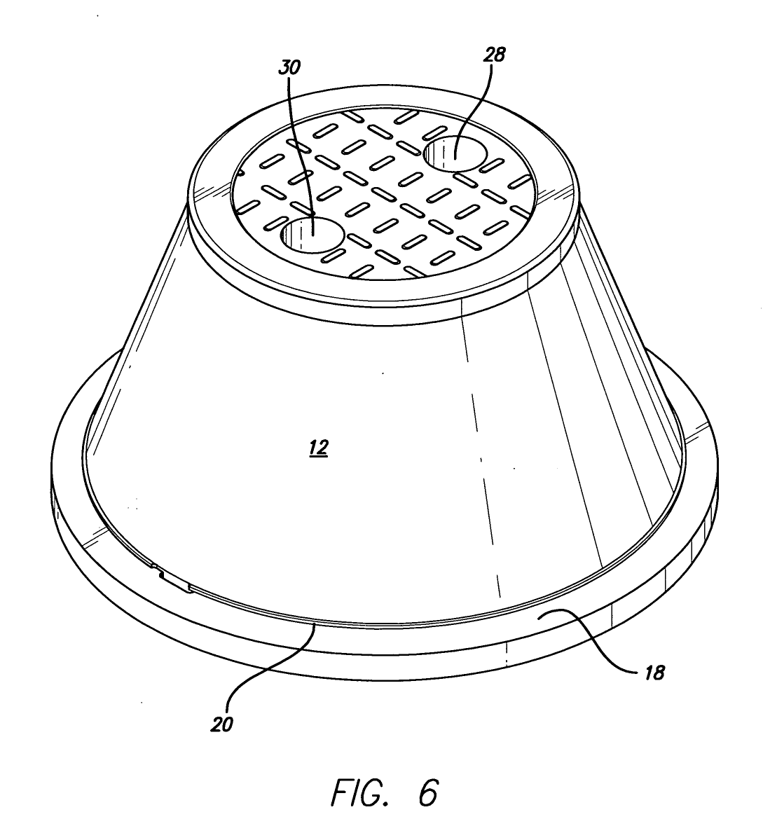

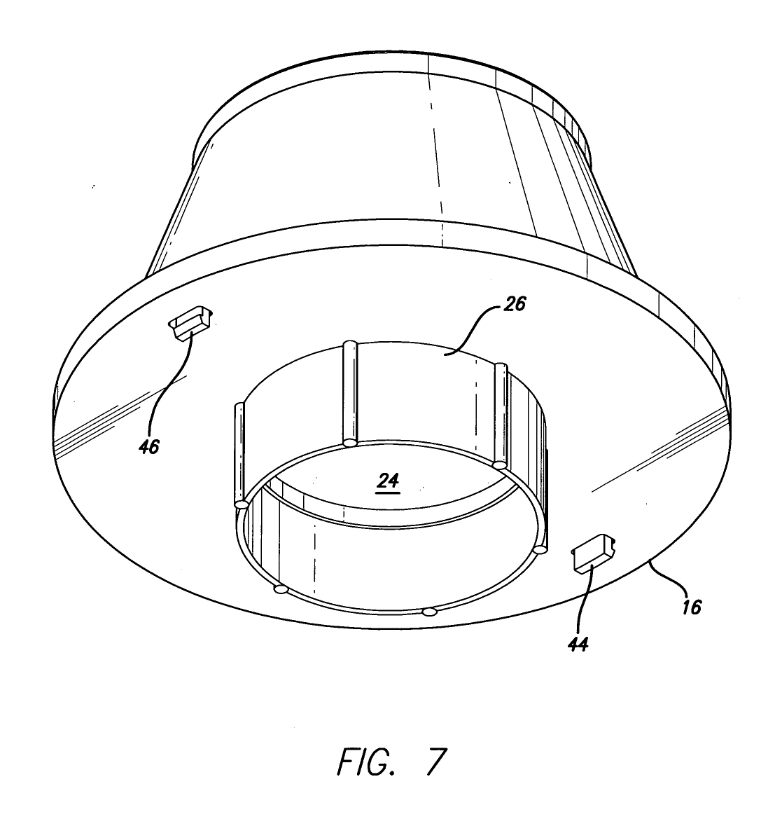

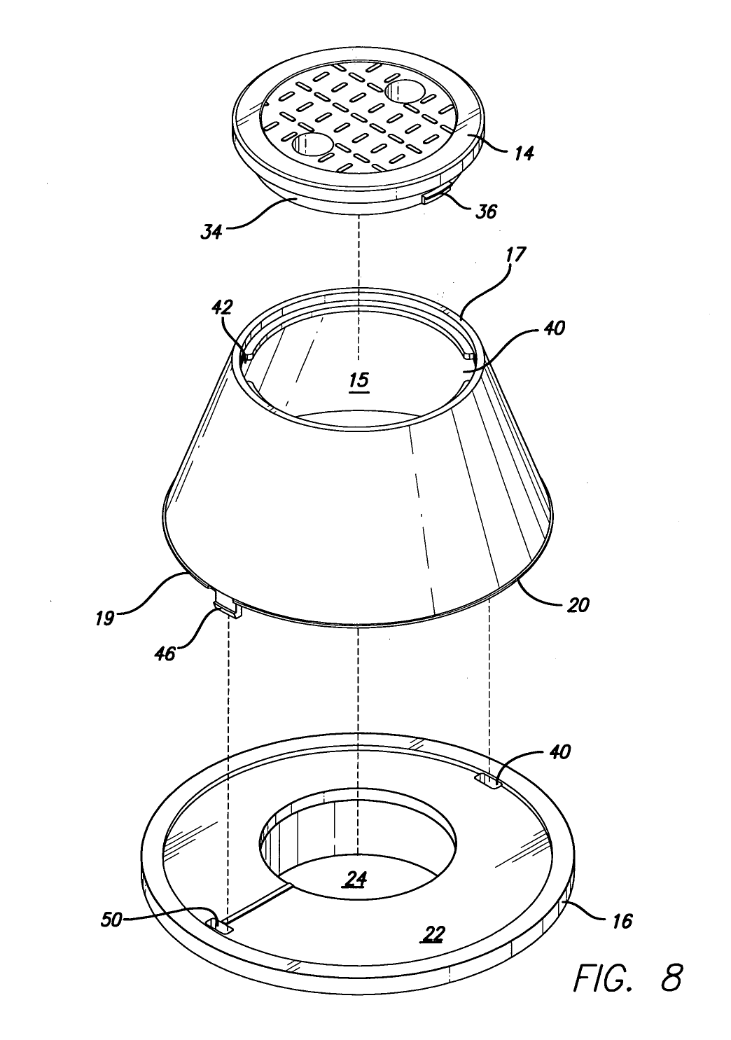

The septic leach line control apparatus 10 in accordance with the present invention is shown in FIG. 1 and comprises control box 11 having tapered continuous curved sidewalls 12, lid 14, which is utilized to close and access opening 15 in top 17, and bottom plate 16, typically round in configuration, which includes integrally formed flange 18 extending outwardly from base 20 and integrally formed flange 22 extending inwardly from base 20. Flange 22 defines opening 24, which includes a vertical extended tubular portion 26. Lid 14 includes multiple openings 28 and 30 for use in removing and installing lid 14. A person's fingers (not shown) may be inserted into openings 28 and 30 to lift or replace lid 14 to access or close opening 15. Any suitable implement (not shown) designed for this purpose may also be utilized. Formed along edge 34 of lid 14 are projections 36 and 38, which are designed to engage corresponding slots 40 and 42 formed within top 17 of control box 11. With a twist (either clockwise or counterclockwise, depending on the actual design), lid 14 may be easily secured to top 17. Clips 44 and 46, which are formed along edge 19 of base 20, are used to secure sidewalls 12 to bottom plate 16 by inserting clips 44 and 46 into corresponding openings 40 and 50 and snapping clips 44 and 46 into place. Inside control box 11 is hollow compartment 32.

Septic leach line control apparatus 10 of the present invention may also include an elongated pipe 52, which is attached at upper end 54 to vertical extended tubular portion 26 of opening 24. Pipe 52 is attached at bottom end 55 to a generic gate valve assembly 56, including in particular a knife gate valve assembly of the type normally used in combination with or as an element of the present invention, buried beneath ground surface 58. Gate valve assembly 56 includes gate valve housing 59 and gate valve 60. Also included is gate valve handle assembly 62, which includes elongated rod 64 operatively connected to gate valve assembly 56 at one end 66 and to handle 68 at opposite end 69. Elongated rod 64 extends upwards within elongated pipe 52 and terminates with its connection to attached handle 68 enclosed within hollow compartment 32 where handle 68 is easily accessible to operate gate valve 60 below.

Connected to gate valve assembly 56 are leach lines 70 and 72 with leach line 70 leading to septic tank 74.

In a typical application of the septic leach line control apparatus 10 of the present invention, gate valve assembly 56 is positioned beneath ground surface 58 where it is integrated with a system that includes leach lines 70 and 72 and septic tank 74 or a conventional sewer system (not shown). Elongated pipe 52 is fitted securely in conforming relation over top section 61 of gate valve housing 59 at bottom end 55 and connected also at upper end 54 to vertical extended tubular portion 26. This results in essentially securing and sealing pipe 52 at both ends ensuring that those junctures are almost, if not entirely, impervious to the most likely of intrusions. Thus, for example, the harmful effects of pests, e.g. gophers and the like, or other ground elements that may be capable of interfering with the operation of handle 68 and gate valve 60 or damaging any of their related components encased within pipe 52 and control box 11, are either minimized or eliminated entirely. Gophers, due to their ability to dig and burrow, if allowed entry into control box 11 or pipe 52, will force dirt into the box and/or the pipe, causing either or both to clog. This obstruction naturally will hinder the operation of the gate valve handle assembly 62 and, in turn, gate valve assembly 56. Gophers and similar types of animals, if allowed to intrude into the aforementioned interior spaces, will also likely chew or gnaw on one or more of the component parts of those assemblies including, for example, a plastic handle and, thus, interfere with their operations.

Other important benefits attributed to the apparatus of the present invention directly result from the unique structural configuration of control box 11. Thus, to maximize the invention's positive aspects, control box 11 is placed in hole 80 excavated in ground 85 to a depth that enables the alignment of top 17 with ground surface 58. Bottom 16 is caused to rest upon dirt shelf 83, which supports box 11. Weight or pressure bearing down upon lid 14 from above, such as the weight of a vehicle (not shown) moving across control box 11, will not compel control box 11 deeper into the ground. Mostly, this is due to the relatively wide base 20 and, more particularly, to bottom plate 16 and integrally formed flanges 18 and 22 extending therefrom, which act to spread the load and resist downward pressure. Upward movement of box 11, for example, due to ground water (not shown) rising from below or freeze thrust resulting from the expansion of frozen ground is resisted by the effect of tapered sidewalls 12, which act to push against the ground packed adjacent sidewalls 12 alongside and above.

Typical approximate dimensions of control box 11 are 5 inches in diameter at the top and 9 inches in diameter at the bottom. The height of control box 11 is typically just under 7 inches. Flange 18 is normally 0.5 inches in width and less than 0.5 inches in thickness. Flange 22 is about 2 inches in width and has a thickness of about 0.25 inches. Opening 24 is approximately 4 inches in diameter. Vertical extended tubular portion 26 measures a little more than 1.5 inches in length and is 4.25 inches in diameter, almost the same diameter as pipe 52, which is slightly smaller in diameter and may vary in length depending on the depth of the gate valve assembly in the ground.

The dimensions and configuration of gate valve assembly 56 and its components, as described herein, and leach lines 70 and 72 and septic tank 74, are typical for any device of this kind, particularly given the intended purpose of the present invention, and also may vary to accommodate the specific requirements of the septic leach line control apparatus.

All of the specified above dimensions given are approximate and may be altered to accommodate the desired objectives of the present invention and any unique challenges presented.

Materials utilized to fabricate the components of the septic leach line control apparatus in accordance with the present invention include, without limitation, any synthetic material made from a wide range of organic polymers such as polyethylene and PVC, metal, wood, or any combination of these materials.

Although the septic leach line control apparatus 10 of the present invention, in its preferred or typical application, usually employs a single control box 11, multiple boxes or an enlarged box with curved or flat sidewalls (round, square, or rectangular in configuration) containing multiple openings to accommodate several gate valve handle assemblies for controlling several corresponding gate valves, may be utilized. In these instances, lids and bottom plates will be configured accordingly.

Additional applications of the present invention include, without limitation, use in combination with a municipal water supply to enable the water flow to be cut off in the event of a break in the system or the need to make repairs. The present invention may also be utilized to cut off materials from flowing into or out of a cistern used to collect farm animal waste and waste water flushed from an animal pen.

Another application includes the use of control box 11 in combination with pipe 52, which is integrated with leach lines connected to the bottom of the pipe on either side. In this application, the control box is employed as a means to visually inspect the level, condition and composition of the water or waste water inside the pipe to determine the need, if any, to shut off the lines.

While the invention will be described in connection with a certain preferred embodiment, it is to be understood that it is not intended to limit the invention to that particular embodiment. Rather, it is intended to cover all alternatives, modifications and equivalents as may be included within the spirit and scope of the invention as defined by the appended claims.

1. A septic leach line control apparatus comprising:
a hollow housing having tapered continuous sidewalls extending from a top section to a wider base at the bottom, said hollow housing having an outer flange extending outwardly from said base and a wider flange extending inwardly from said base, said inner flange defining a partial bottom and a vertically disposed extended opening integrally formed in said bottom and conformed to engage an elongated pipe, said pipe having a top end and a bottom end.

2. The septic leach line control apparatus of claim 1 further including:
a gate valve assembly, said gate valve assembly having a gate valve housing and a gate valve; and,
a gate valve handle assembly, said gate valve handle assembly having a handle and an elongated rod operatively connected to said gate valve, said elongated rod connecting said handle to said gate valve and extending vertically through said elongated pipe and said opening into said hollow housing, said bottom end of said pipe at least partially enclosing said gate valve housing.

3. An apparatus for disposition in the ground for controlling and monitoring the flow of water and waste materials, comprising:
a hollow housing having a top section generally level with said ground surface and tapered continuous sidewalls extending from said top section to a wider base at the bottom, said hollow housing having an outer flange extending outwardly from said base and a wider flange extending inwardly from said base, said inner flange defining a partial bottom and a vertically disposed extended opening integrally formed in said bottom and conformed to engage an elongated pipe, said pipe having a top end and a bottom end.

4. The apparatus of claim 3 further including:
a gate valve assembly, said gate valve assembly having a gate valve housing and a gate valve; and,
a gate valve handle assembly, said gate valve handle assembly having a handle and an elongated rod operatively connected to said gate valve, said elongated rod connecting said handle to said gate valve and extending vertically through said elongated pipe and said opening into said hollow housing, said bottom end of said pipe at least partially enclosing said gate valve housing.
